(19) United States
(12) Patent Application Publication
(10) Pub. No.: US 2024/0125343 A1
(43) Pub. Date: Apr. 18, 2024

(54) PIN STRUCTURES AND ACCESSORIES WITH VIAS FOR ATTACHING PIN STRUCTURES

(71) Applicant: Doria International Inc, Los Angeles, CA (US)

(72) Inventor: Shem Paul McCullough, Wildomar, CA (US)

(21) Appl. No.: 18/117,331

(22) Filed: Mar. 3, 2023

Related U.S. Application Data
(60) Provisional application No. 63/417,285, filed on Oct. 18, 2022.
(60) Provisional application No. 63/436,054, filed on Dec. 29, 2022.

(51) Int. Cl. F16B 21/14; H04M 1/02

(52) U.S. Cl. CPC F16B 21/14; H04M 1/0254

(57) ABSTRACT

A pin structure, comprises an external piece; a shaft coupled to the external piece and configured to extend into a via in an accessory; and a retention component couped to the shaft and configured to interact with the via to retain the pin structure to the accessory.

### PRIORITY CLAIM

This application claims benefit of and hereby incorporates by reference provisional application Ser. No. 63/417,285, entitled “Pin Structures and Accessories with Through Vias for Receiving Pin Structures,” filed on Oct. 18, 2022, by Shem Paul McCullough, and provisional application Ser. No. 63/436,054, entitled “Pin Structures and Accessories with Through Vias for Receiving Pin Structures,” filed on Dec. 29, 2022, by Shem Paul McCullough.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

This invention relates generally to pin structures, and more particularly provides pin structures and accessories with vias for attaching pin structures.

### BACKGROUND

Many accessories exist, such as phone cases, headphones, phone chargers, electronic device sleeves (e.g., stylus sleeves, remote control sleeves), product packaging, tablet cases, laptop stands, keyboards, earbud cases, bags, backpacks, duffel bags, purses, stadium bags, dog collars, dog apparel, apparel, hats, and more. Many people enjoy differentiating their accessories by attaching stickers to them. Stickers are somewhat permanent and often damage the products when the stickers are removed. Other ways of differentiating accessories would be helpful.

### SUMMARY

Embodiments of the invention include a pin structure that can be removably attached to accessories having vias (e.g., perforations, holes, grommets, cavities, etc.). Example accessories may include phone cases, headphones, phone chargers, electronic device sleeves (e.g., stylus sleeves, remote control sleeves), product packaging, tablet cases, laptop stands, keyboards, earbud cases, bags, backpacks, duffel bags, purses, stadium bags, dog collars, dog apparel, apparel, hats, and more. Embodiments of the invention may include any of these or other accessories with one or more vias therein.

In accordance with some embodiment, the present invention provides a pin structure, comprising an external piece; a shaft coupled to the external piece and configured to extend into a via in an accessory; and a retention component couped to the shaft and configured to interact with the via to retain the pin structure to the accessory.

In some embodiments, the external piece may be decorative. The external piece may include a functional component. The shaft may include a width smaller than a width of the via. The shaft may include a length slightly longer than a length of the via. The shaft may include a length shorter than a length of the via. The retention component may include a widest part with a width larger than a width of the via. The retention component may include a cylindrical portion and a conical slice portion. The conical slice potion may include a distal end with width smaller than a width of the via. The shaft and retention component may include flat opposing sides. The pin structure may comprise at least one additional shaft coupled to the pin structure and at least one additional retention component coupled to the at least one additional shaft. The two or more shafts and two or more retention components may be configured to be inserted into adjacent vias in the accessory. The shaft and the retention component may have a hollow section therein or therethrough. The via may have a set size on two or more of different accessories, and the connecting rod may be configured to cooperate with the via of the set size. The via may have a set size on two or more of a phone case, headphone, phone charger, electronic device sleeve, product package, tablet case, laptop stand, keyboard, earbud case, backpack, duffel bag, purse, stadium bag, dog collar, dog apparel or human apparel, and the connecting rod may be configured to cooperate with the via of the set size. The external piece and the shaft may be separable. The via in the accessory may include a grommet-based accessory. The shaft and the retention component may be integrally formed. The shaft and retention component may be different portions of screw-based threading.

### BRIEF DESCRIPTION OF THE DRAWINGS

FIG. 1 illustrates a pin structure attached to a phone case accessory with a pattern of vias, in accordance with some embodiments of the present invention.

FIG. 2 illustrates details of a pin structure, in accordance with some embodiments of the present invention.

FIG. 3 is an exploded view of the pin structure of FIG. 2, in accordance with some embodiments of the present invention.

FIG. 4 illustrates an example pin structure with multiple connecting rods, in accordance with some embodiments of the present invention.

FIG. 5 illustrates the external side of a phone case accessory with three pin structures attached to it, in accordance with some embodiments of the present invention.

FIG. 6 illustrates an internal side of a phone case accessory with a few pin structures attached to the external side, in accordance with some embodiments of the present invention.

FIG. 7 is a perspective bottom side view of the phone case accessory illustrating connecting rods extending through several vias, and the retention components of the connecting rods retaining the pin structures to the phone case accessory, in accordance with some embodiments of the present invention.

FIG. 8 illustrates the external side of a phone case accessory having multiple pin structures attached to it and a phone contained therein, in accordance with some embodiments of the present invention.

FIG. 9 is a cross-sectional view of the phone case accessory with vias and a pin structure with connecting rods, thereby illustrating the shafts extending through two adjacent vias, the external piece resting flush on the external surface of the phone case accessory, and the retention components of the connecting rods locking the pin structure the internal surface of the phone case accessory, in accordance with some embodiments of the present invention.

FIGS. 10-16 are various perspectives of an example phone case accessory with a pattern of vias, in accordance with some embodiments of the present invention. FIG. 10 is an external left, bottom perspective view. FIG. 11 is an internal view. FIG. 12 is an external view. FIG. 13 is a right side view. FIG. 14 is a left side view. FIG. 15 is a bottom side view. FIG. 16 is a top side view.

FIGS. 17-22 are various perspective views of an example backpack accessory with grommet-based vias, in accordance with some embodiments of the present invention. FIG. 17 illustrates a front view of the backpack accessory having front and top straps with a pattern (e.g., a row/column) of grommet-based vias. FIG. 18 illustrates a front view of the backpack accessory having front and top straps with several pin structures in the grommet-based vias.

FIG. 19 illustrates a front close-up view of the backpack accessory having front straps with several pin structures in the grommet-based vias. FIG. 20 illustrates another front close-up view of the backpack accessory having front and top straps with several pin structures in the grommet-based vias. FIG. 21 illustrates a back view of the backpack accessory having shoulder straps with a pattern (e.g., a row/column) of grommet-based vias and pin structures therein. FIG. 22 illustrates a back view of the backpack accessory having shoulder straps (and top straps) with several pin structures in the grommet-based vias.

FIGS. 23 and 24 are various perspective views of an example duffel bag accessory with grommet-based vias, in accordance with some embodiments of the present invention. FIG. 23 illustrates a side perspective view of the duffel bag accessory having straps with a pattern of grommet-based vias. FIG. 24 illustrates another side perspective view of the duffel bag having straps with several pin structures in the grommet-based vias.

FIG. 25 is a perspective view of an example bag accessory with grommet-based vias in the face portion of the bag as well as on straps, in accordance with some embodiments of the present invention.

FIGS. 26 and 27 are various perspective views of an example stadium bag accessory product (larger bag accessory and nesting bag accessory) with a pattern of grommet-based vias on the side face of the each of the larger bag accessory and nesting bag accessory, in accordance with some embodiments of the present invention.

FIG. 28 is a perspective view of two grommet-based vias in one of the larger bag accessory or the nesting bag accessory, with the right grommet-based via having a pin structure retained therein, in accordance with some embodiments of the present invention.

FIG. 29 illustrates an example earbud case accessory with a pattern of vias, in accordance with some embodiments of the present invention.

FIG. 30 illustrates the example earbud case accessory of FIG. 29 with several pin structures in the vias, in accordance with some embodiments of the present invention.

FIG. 31 illustrates an example headphone accessory with a pattern of vias, in accordance with some embodiments of the present invention.

FIG. 32 illustrates the example headphone accessory of FIG. 31 with several pin structures in the vias, in accordance with some embodiments of the present invention.

FIG. 33 illustrates an example wireless speaker accessory with a pattern of vias, in accordance with some embodiments of the present invention.

FIG. 34 illustrates the example wireless speaker accessory of FIG. 33 with several pin structures in the vias, in accordance with some embodiments of the present invention.

### DETAILED DESCRIPTION

The following description is provided to enable a person skilled in the art to make and use various embodiments of the invention. Modifications are possible. The generic principles defined herein may be applied to the disclosed and other embodiments without departing from the spirit and scope of the invention. Thus, the claims are not intended to be limited to the embodiments disclosed, but are to be accorded the widest scope consistent with the principles, features and teachings herein.

Embodiments of the invention include a pin structure that can be removably attached to accessories having vias (e.g., perforations, holes, grommets, cavities, etc.). Example accessories may include phone cases, headphones, phone chargers, electronic device sleeves (e.g., stylus sleeves, remote control sleeves), product packaging, tablet cases, laptop stands, keyboards, earbud cases, bags, backpacks, duffel bags, purses, stadium bags, dog collars, dog apparel, clothing, hats, and more. Embodiments of the invention may include any of these or other accessories with one or more vias therein.

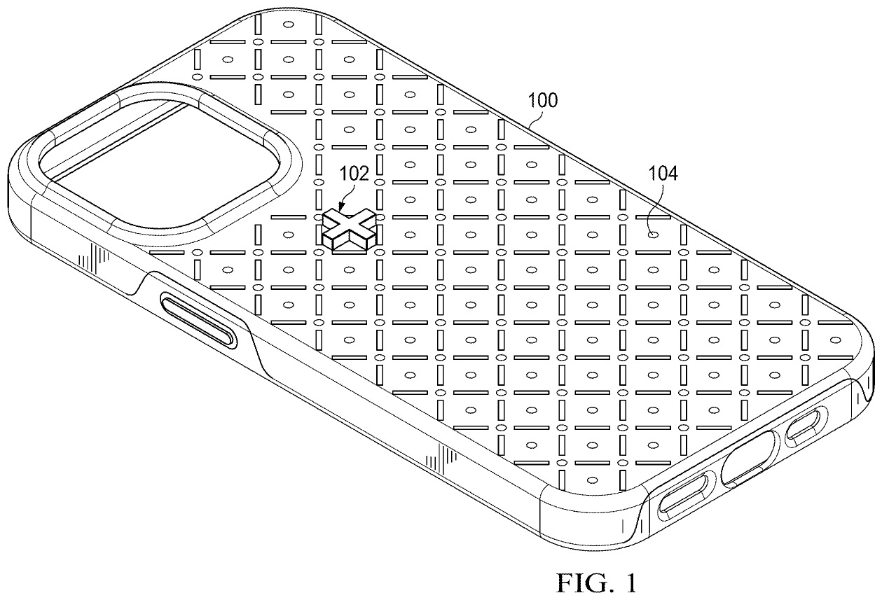

FIG. 1 illustrates a pin structure 102 attached to a phone case accessory 100 with a pattern of vias 104, in accordance with some embodiments of the present invention. In the illustrated embodiment, the phone case accessory 100 includes an iPhone phone case with a diamond pattern of vias 104 across the back. Each via 104 may include a perforation through the phone case accessory 100. In some embodiments, one, some or all of the vias 104 may include a grommet (e.g., a metal or plastic grommet) therein. The shape of the via 104 may include cylindrical tunnel, having a circular perimeter at the entrance (on the external side) and at the exit (on the internal side) and may include a smooth wall therebetween. In some embodiments, the perimeter shape may be a different shape such as diamond, rectangular, oval, square, etc. In some embodiments, the wall surface may be jagged or rough to add friction to support retention of the pin structure 102. In some embodiments, the wall surface may include anatomy (e.g., threading) to support retention of the pin structure 102. In some embodiments, the via 104 may be 1-3 mm, 2-3 mm, under 3 mm, under 2 mm, over 2 mm or 2-4 mm.

Notably, the pin structure 102 may include a decorative or functional external piece. In the illustrated embodiment, the external piece includes a cross pattern.

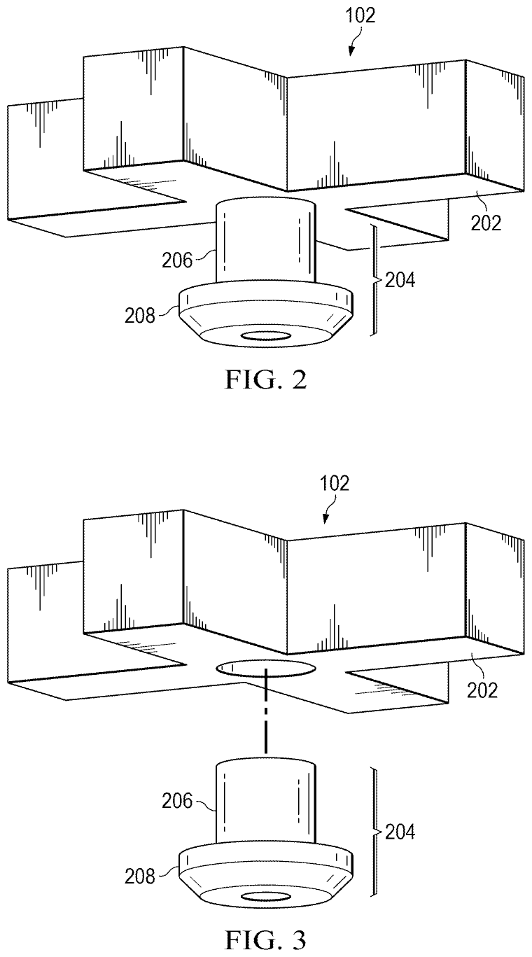

FIG. 2 illustrates details of a pin structure 102, in accordance with some embodiments of the present invention. The pin structure 102 includes an external piece 202 coupled to a connecting rod 204. In some embodiment, the connecting rod 204 includes a shaft 206 coupled to a retention component 208.

In some embodiments, mating structure (not shown) may attach the external piece 202 to the connecting rod 204. The mating structure may include glue, complementary thread sets, elastic gripping mechanisms, mechanical grips, biasing members, frictional engagement mechanisms, magnets, clips and/or other complementary mating features. In some embodiments, the external piece 202 and connecting rod 204 may be formed as a single structure, e.g., a single mold. In an integral embodiment, the mating structure is integrated.

In some embodiments, the external piece 202 may include a design element, e.g., which may include an ornamental image. In some embodiments, the external piece 202 may have one or more functional elements, such as a spinner, magnet, mirror, screen cleaner, magnifying glass, pen, hair clip, pocket, etc.

In some embodiments, the connecting rod 204 includes a shaft 206 and a retention component 208 (e.g., flange, edge, lip, threading, lateral extension, brad, nut/bolt, etc.). The shaft 206 may be sized to have a width (e.g., a diameter) approximately the same or slightly smaller than the width of the vias 104. Each retention component 208 may be sized so that its widest part has a width (e.g., diameter) larger than the width of the vias 104 (or at least larger than the width of the exit (internal opening) of the vias 104. Each shaft 206 may be sized to include a length that is shorter than, as long as, or longer than the vias 104. Accordingly, the shaft 206 may extend partially into a via 104, entirely through a via 104 or past the internal surface of a via 104. The retention component 208 may be sized to include a length sufficient to prevent it from bending or breaking during insertion or withdrawal, and possibly short enough to avoid interfering with any objects on the internal side of the accessory 100 if the shaft 206 positions the retention component 208 through the via 104. In some embodiments, the shaft 206 may be sized to have a length shorter than the via 104 so that the retention component 208 resides in the via 104 when fully inserted and does not interfere with the function or design of the accessory 100. The shaft 206 may be sized to have a length equal to the via 104 so that the retention component 208 can lock to the internal surface of the accessory 100 but extend a little as possible past the internal surface. The retention component 208 may be sized thin with a flat terminal surface to reduce or avoid interference with the function or design of the accessory 100. In some embodiments, the retention component 208 may be only slightly wider than the width of the via 104, so that the retention component can be pulled, rotated or otherwise extracted manually out of a via 104 with a reasonable amount of force and without breaking or disconnecting the connecting rod 204 from the external piece 202 or the retention component 208 from the shaft 206.

In some embodiments, the length of the shaft 206 is designed to be less than the thickness of the via 104, so that the retention component 208 can cooperate with the via wall of the via 104. In some embodiments, the shaft 206 and the retention component 208 are part of the same element (integrated as a single element), e.g., threading, brad, or other member.

In some embodiments, the retention component 208 may include a cylindrical disk shaped portion that cooperates with the via wall or locks the pin structure 102 to the accessory 104, and a conical or width-reducing slice portion that helps to direct the retention component into the via 104. The conical or width-reducing slice portion may be designed to reduce the width of the retention component 208 towards its distal end so that the distal end is smaller than the width of the via 104. In some embodiments, the retention component 208 does not have a conical slice portion. In some embodiments, the retention component 208 does not have a cylindrical component. Other embodiments include different retention components 208.

In some embodiments, the shaft 206 and/or retention component 208 may include a hollow section therein or entirely therethrough.

Each via 104 may have a set size on two or more of different accessories 100, and the connecting rod 204 may be configured to cooperate with the via 104 of the set size. The via 104 may have a set size on two or more of a phone case, headphone, phone charger, electronic device sleeve, product package, tablet case, laptop stand, keyboard, earbud case, backpack, duffel bag, purse, stadium bag, dog collar, dog apparel or human apparel, and the connecting rod 204 may be configured to cooperate with the via 104 of the set size.

In some embodiments, the pin structure 102 may include multiple connecting rods 204 for extending through multiple vias 104. The multi-connecting rod pin structure 102 may support larger decorative pieces and may prevent the pin structure 102 from rotating. The multiple connecting rods 204 of a multi-connecting rod pin structure 102 may extend into or through adjacent vias 104 or non-adjacent vias 104. In some embodiments, the external piece 202 and the multiple connecting rods 204 may use multiple mating structures (not shown) to connect them together.

In some embodiments, the pin structure 102 can be pulled off the accessory 100 by pulling on the external piece 202, which will cause the retention component 208 to be pulled through the via 104 without breaking. In some embodiments, when the external piece 202 and connecting rod 204 are separate structures, the external piece may be removed and replaced without removing the connecting rod 204 from its via 104. In the example of a phone case accessory 100, in some embodiments, the pin structure 102 in its entirety or the external piece 202 separably from the connecting rod 204 can be removed and replaced without removing the phone from the phone case accessory 100. In some embodiments, when the external piece 202 and connecting rod 204 are separate structures, the connecting rod 204 may be positioned into the via 104 from the internal side and the external piece 202 can be connected to the connecting rod 204 (e.g., using a mating structure).

As illustrated, the external piece 202 may be a decorative cross. In some embodiments, each of the connecting rod 204 and the external piece 202 may include complementary mating structure to connect them together. For example, in some embodiments, the cross pattern structure may be considered a part of the connecting rod 204 and may be used to couple the connecting rod 204 to various external pieces 202 (whether decorative or functional), e.g., via magnetics or friction.

In some embodiments, each part of the pin structure 102 may be manufactured as a unibody construction with a Thermoplastic Polyurethane (TPU) material, which is durable and strong as well as elastic, flexible, and smooth so as not to damage the accessory 100. Other materials, including harder materials such as rubber or hard plastic, can be used. In some embodiments, a phone case accessory 100 with vias 104 may be manufactured from Polycarbonate (PC) material.

In some embodiments, only the connecting rod 204 (and possibly the mating structure) is made of TPU material. The decorative and/or functional portion of the external piece 202 may be manufactured from any other materials (fabric, plastics, metals, rubbers, paint, etc.). The external piece 202 may form any ornamental design (e.g., flowers, images, words, loops, clips, animals, professional decorations, hobby decorations, marketing images, etc.). As stated above, the decorative piece 202 may include functional components or may be entirely functional.

FIG. 3 is an exploded view of the pin structure 102, in accordance with some embodiments of the invention. As shown, the pin structure 102 may include an external piece 202 and a connecting rod 204. The external piece 202 and connecting rod 204 may be separable or integrally formed. When separable, a mating structure (not shown) will be used to couple them together. As stated above, the mating structure may include glue, complementary thread sets, elastic gripping mechanisms, mechanical grips, biasing members, frictional engagement mechanisms, magnets, clips and/or other complementary mating features. Although not shown, the shaft 206 and retention component 208 may be separable or integrally formed. When separable, a mating structure (not shown) will be used to couple them together.

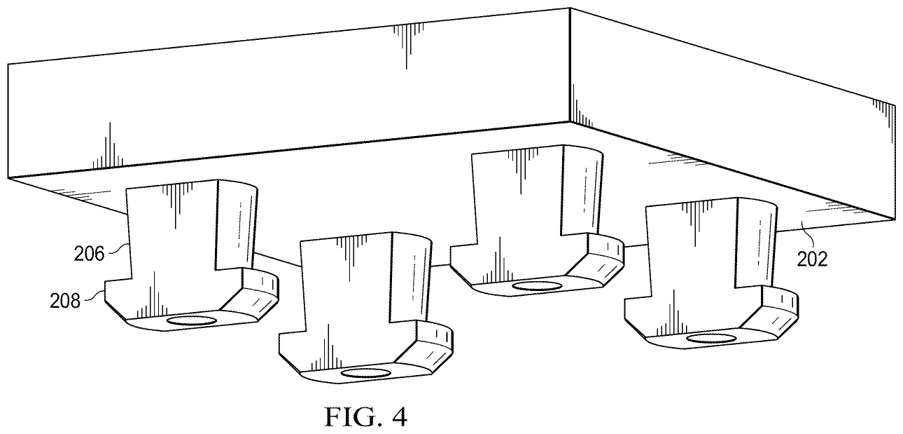

FIG. 4 illustrates an example pin structure 102 with multiple connecting rods 204, in accordance with some embodiments of the present invention. As illustrated, each of the connecting rods 204 have a shaft 206 and a retention component 208. In the illustrated embodiment, the shaft 206 is not cylindrical and may be shaped with one or more flat sides, such that each flat side appears as though one or more side portions, possibly opposite side portions, of an otherwise curved (e.g., rounded) form, has/have been vertically sliced off. Similarly, as illustrated, the retention components 208 may be shaped with one or more flat sides, such that each flat side appears as though one or more side portions, possibly opposite side portions, of an otherwise curved (e.g., rounded) form has/have been vertically sliced off (in the same plane as the one or more side portions of the shafts 206).

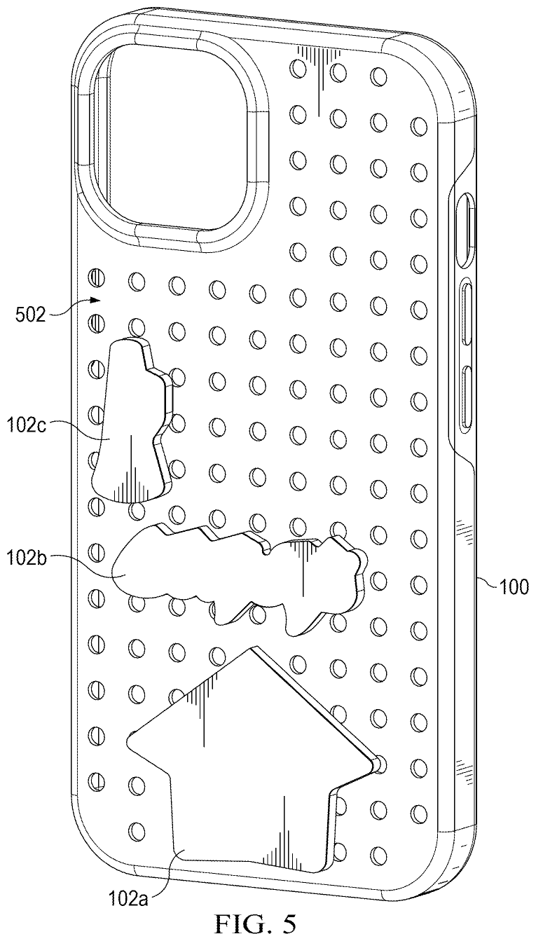

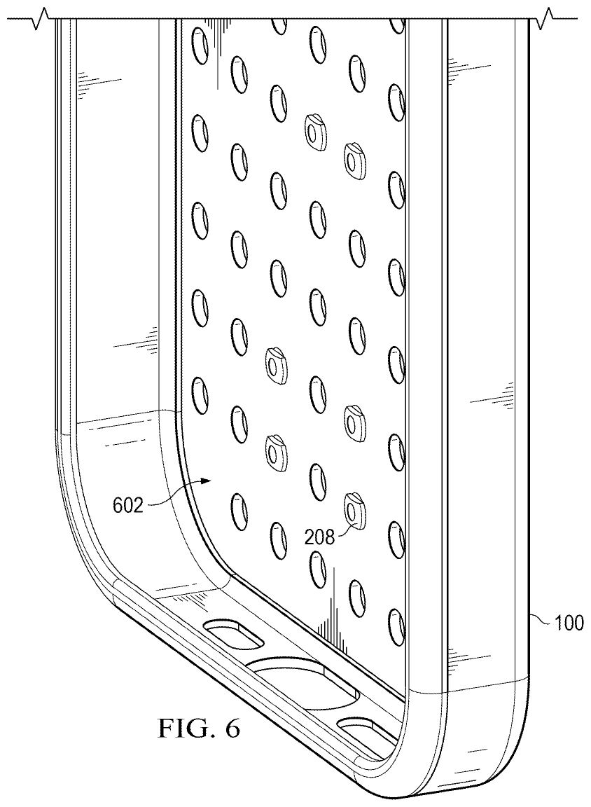

FIG. 5 illustrates the external side 502 of a phone case accessory 100 with three pin structures 102a, 102b and 102c attached to it, in accordance with some embodiments of the present invention. Although not shown, the connecting rods 204 have been pressed within the vias 104 to thereby retain the pin structures 120a, 102b and 102c to the phone case accessory 100.

FIG. 6 illustrates an internal side 602 of a phone case accessory 100 with a few pin structures 102 attached to the external side 502, in accordance with some embodiments of the present invention. As shown, multiple retention components 208 of multiple connecting rods 204 are exposed through the vias 104 of the phone case accessory 104.

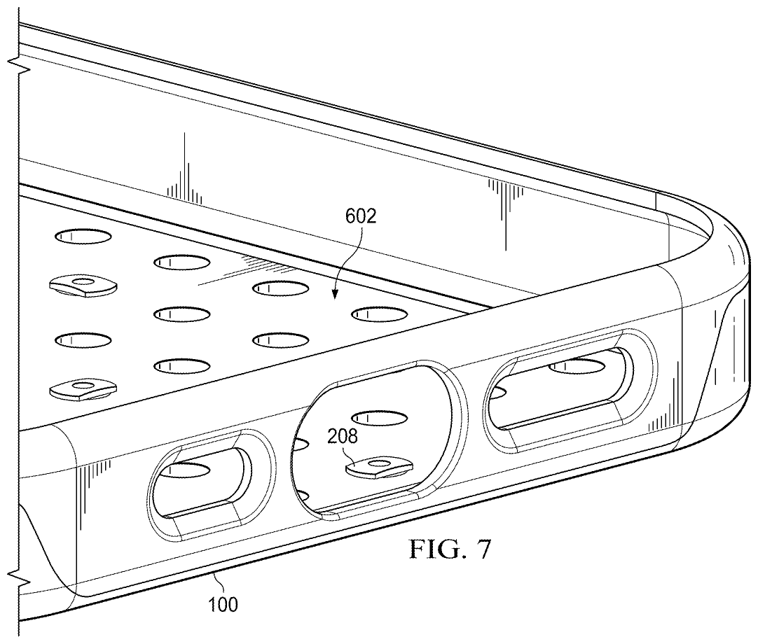

FIG. 7 is a perspective view of the internal side 602 of the phone case accessory 100 and illustrating multiple retention components 208 of multiple connecting rods 204 exposed through the vias 104 and locking the pin structures 102 to the phone case accessory 100, in accordance with some embodiments of the present invention.

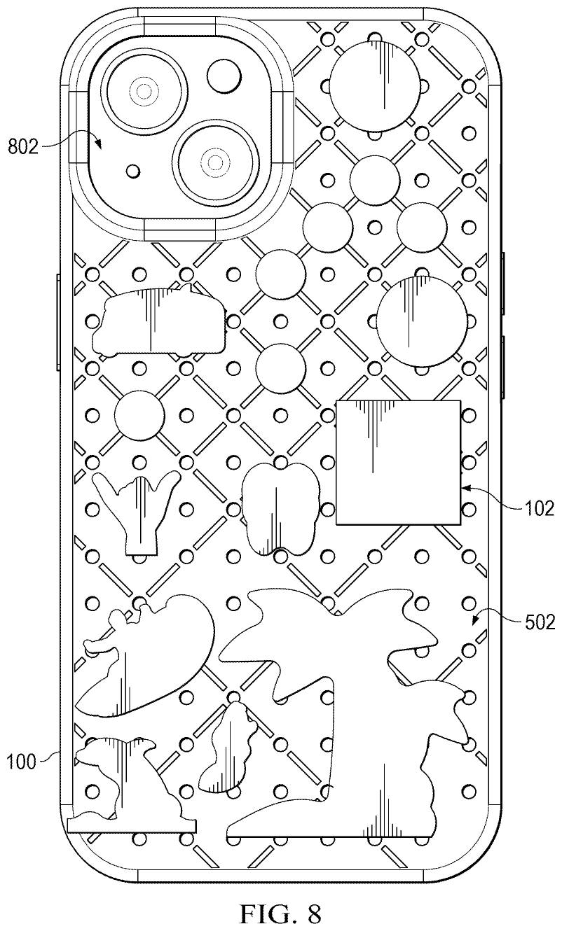

FIG. 8 illustrates the external side 502 of a phone case accessory 100 having multiple pin structures 102 attached to it and a phone 802 contained therein, in accordance with some embodiments of the present invention.

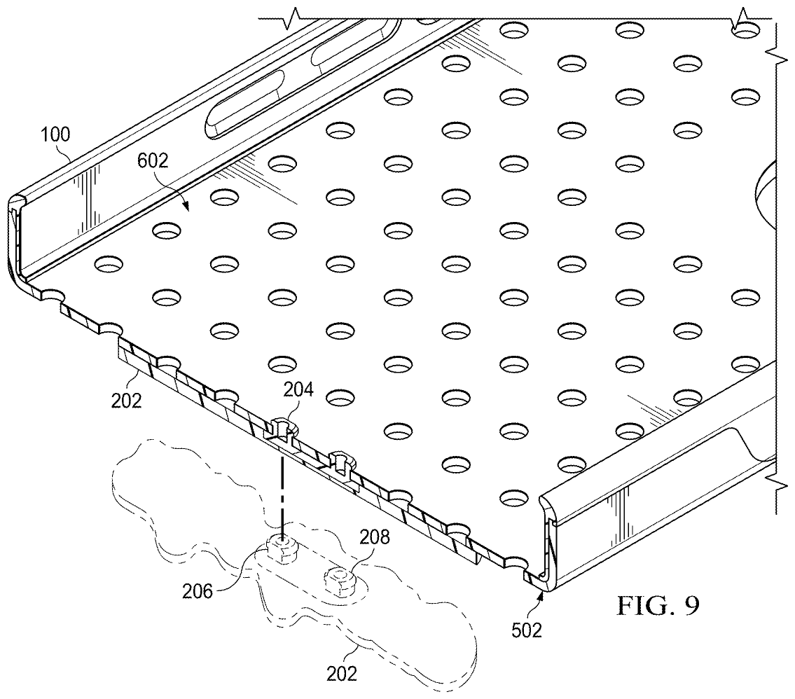

FIG. 9 is a cross-sectional view of a phone case accessory 100 with vias 104 and a pin structure 102 with connecting rods 204. The cross-sectional view illustrates the shafts 206 extending through two adjacent vias 104, the external piece 202 resting flush on the external side 502 of the phone case accessory 100, and the retention components 208 locking the pin structure 102 to the internal side 602 of the phone case accessory 100, in accordance with some embodiments of the present invention.

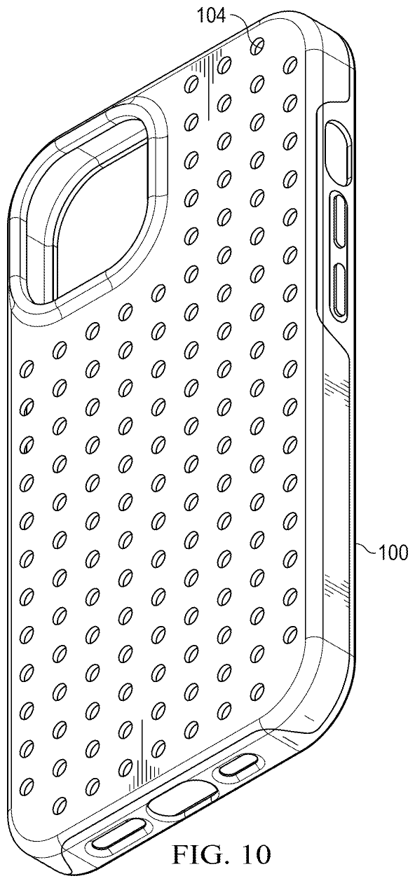

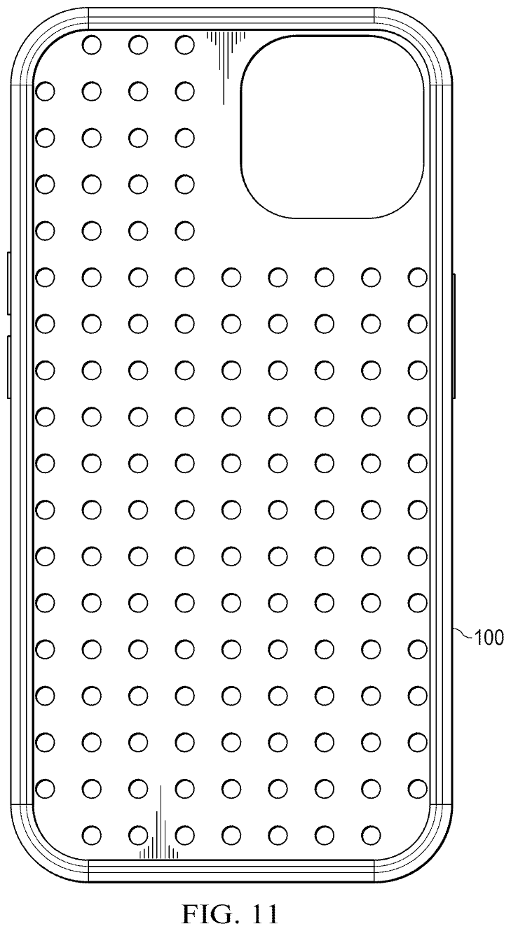

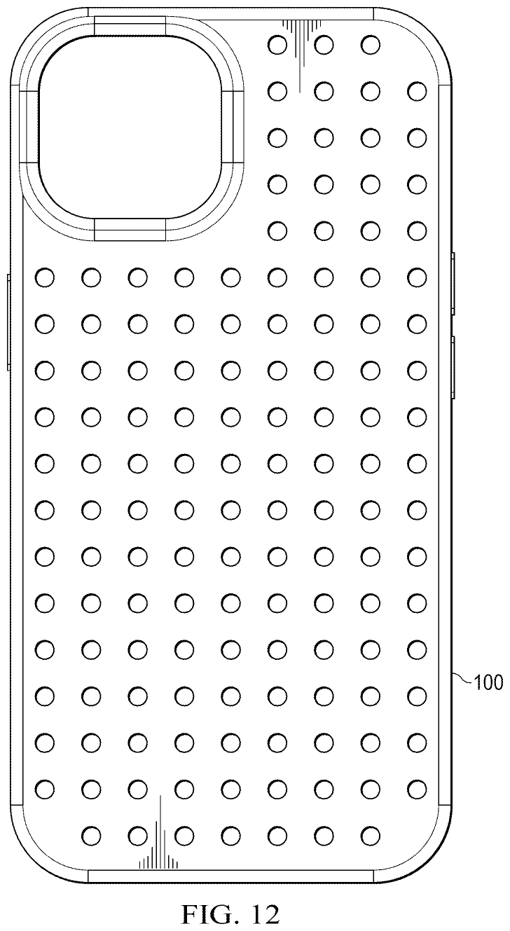

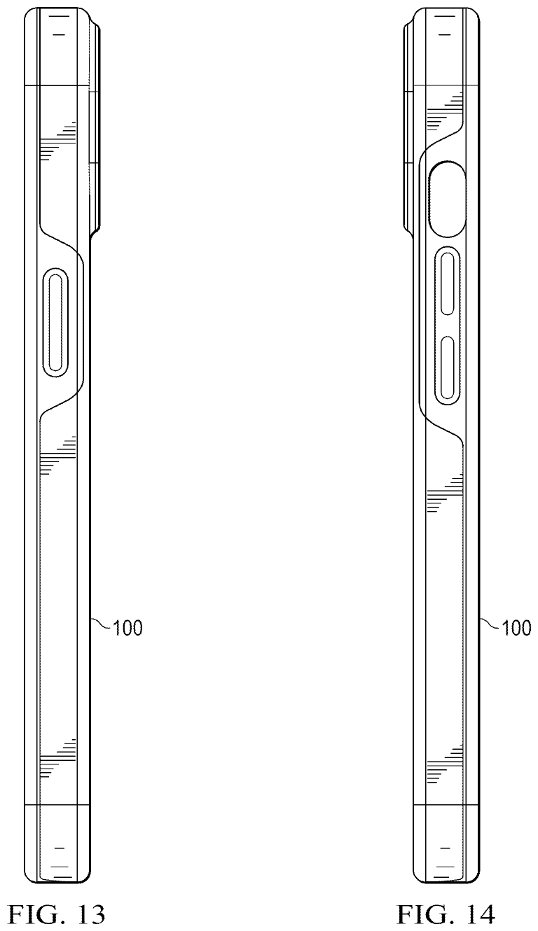

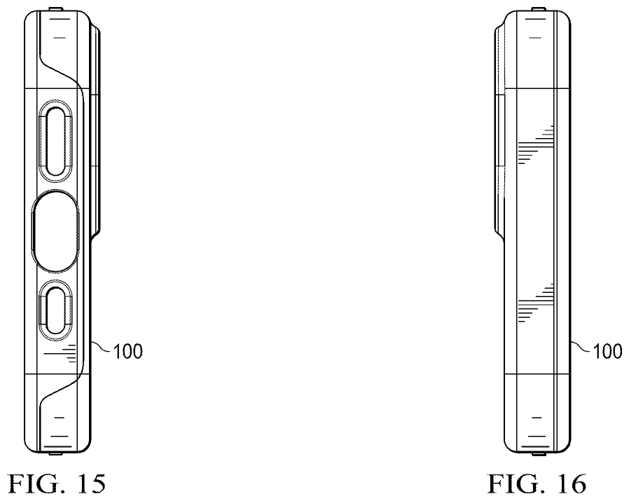

FIGS. 10-16 are various perspectives of an example phone case accessory 100 with a pattern of vias 104, in accordance with some embodiments of the present invention. FIG. 10 is an external left, bottom perspective view. FIG. 11 is an internal view. FIG. 12 is an external view. FIG. 13 is a right side view. FIG. 14 is a left side view. FIG. 15 is a bottom side view. FIG. 16 is a top side view.

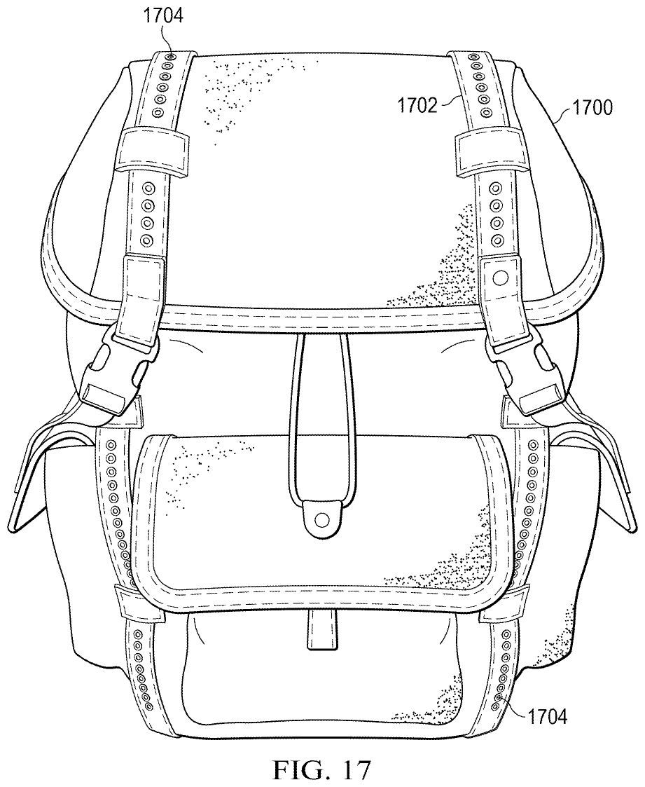

FIGS. 17-22 are various perspective views of an example backpack accessory 1700 with grommet-based vias 1704 and pin structures 102 therein, in accordance with some embodiments of the present invention.

FIG. 17 illustrates a front view of the backpack accessory 1700 having front and top straps 1702 with a pattern (e.g., a row/column) of grommet-based vias 1704, in accordance with some embodiments of the present invention. The grommet-based vias 1704 may be sized to include the same dimensions as the vias 104 of the phone-based accessory 100. Accordingly, the same pin structures 102 may be used with vias 104 and the grommet-based vias 1704. In other embodiments, the grommet-based vias 1704 may be sized differently to accept different pin structures 102 with different connecting rods 204 of different size or configuration. In some embodiments, the grommet-based vias 1704 may be sized to include the same width as the phone case vias 104, but to include a different length. Accordingly, in some embodiments, the connecting rod 204 may be sized to extend through the vias 104 but not through the grommet-based vias 1704.

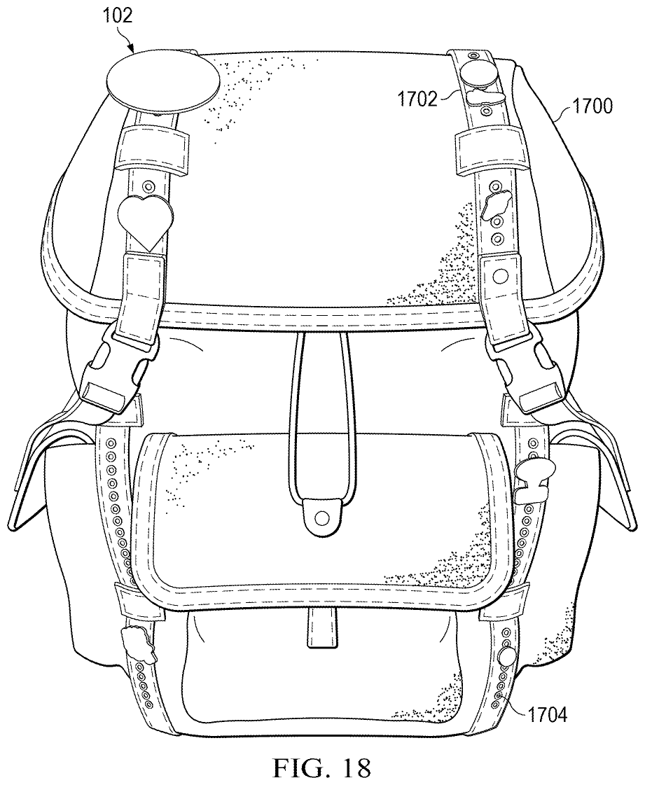

FIG. 18 illustrates a front view of the backpack accessory 1700 having front and top straps 1702 with several pin structures 102 in the grommet-based vias 1704, in accordance with some embodiments of the present invention.

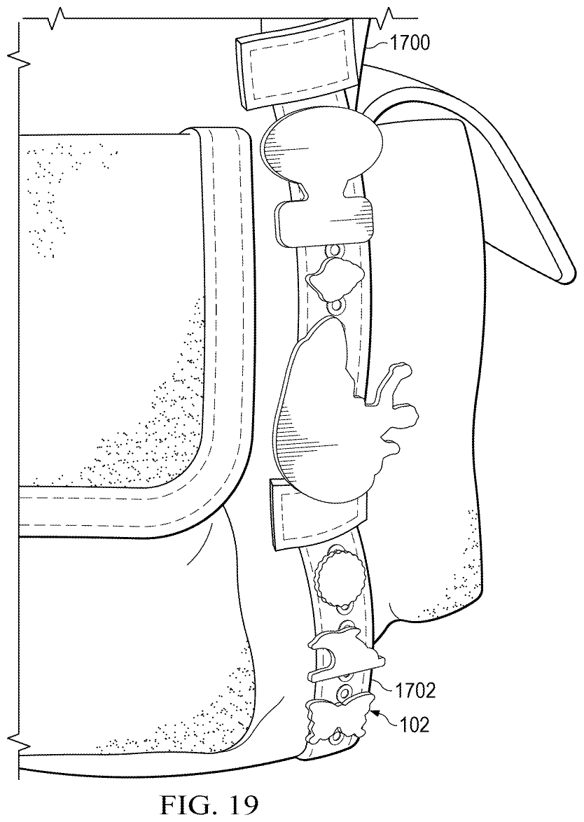

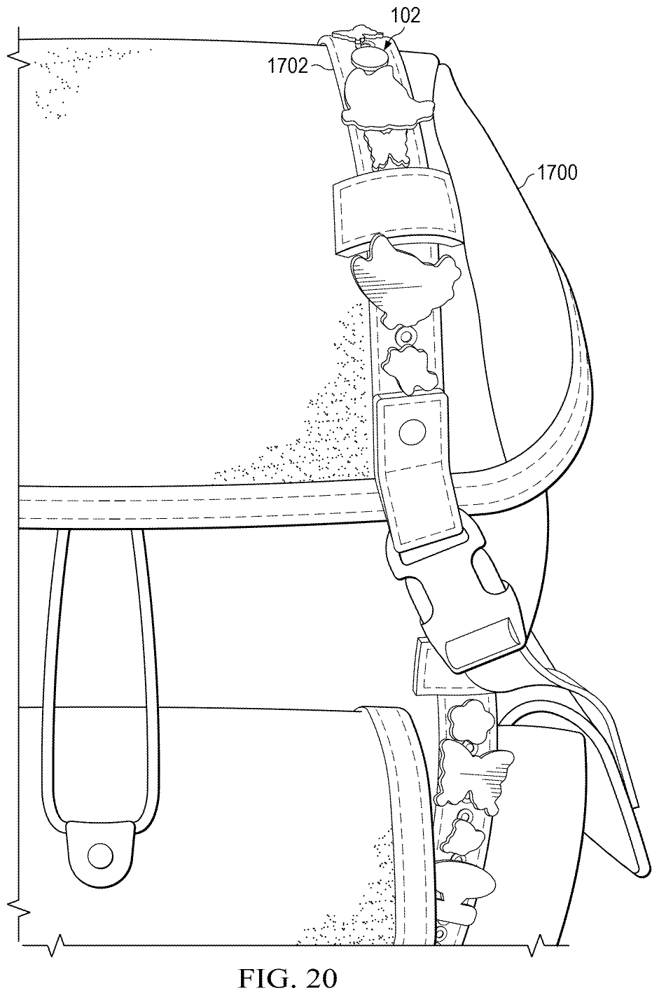

FIG. 19 illustrates a front close-up view of the backpack accessory 1700 having front straps 1702 with several pin structures 102 in the grommet-based vias 1704, in accordance with some embodiments of the present invention.

FIG. 20 illustrates another front close-up view of the backpack accessory 1700 having front and top straps 1702 with several pin structures 102 in the grommet-based vias 1704, in accordance with some embodiments of the present invention.

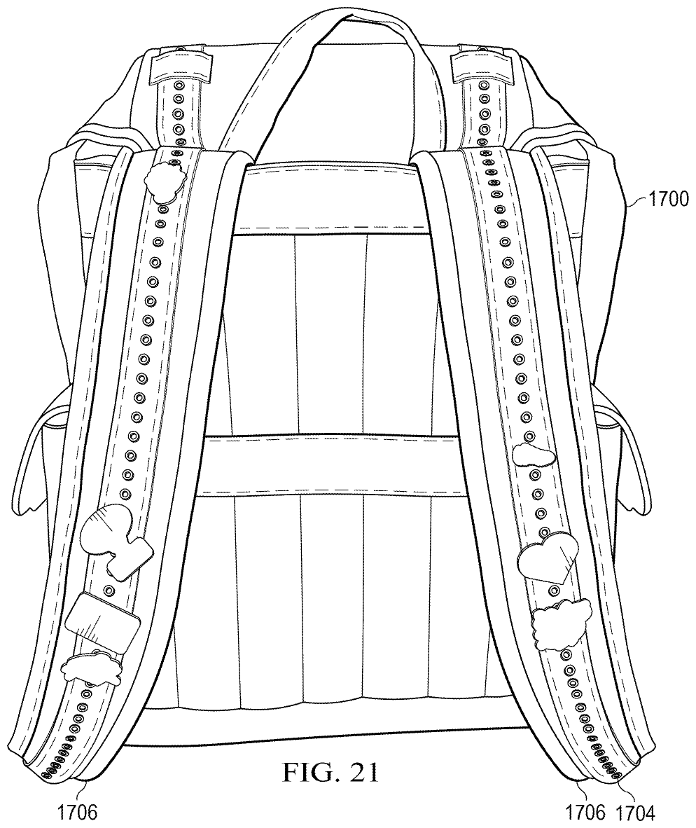

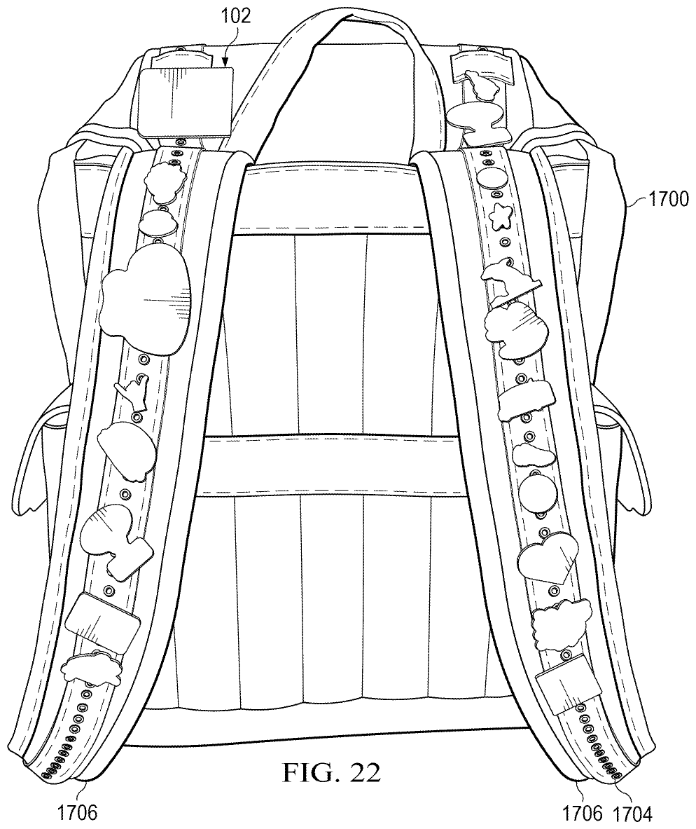

FIG. 21 illustrates a back view of the backpack accessory 1700 having shoulder straps 1706 with a pattern (e.g., a row/column) of grommet-based vias 1704 and pin structures 102 therein, in accordance with some embodiments of the present invention.

FIG. 22 illustrates a back view of the backpack accessory having shoulder straps 1706 (and top straps 1702) with several pin structures 102 in the grommet-based vias 1704, in accordance with some embodiments of the present invention.

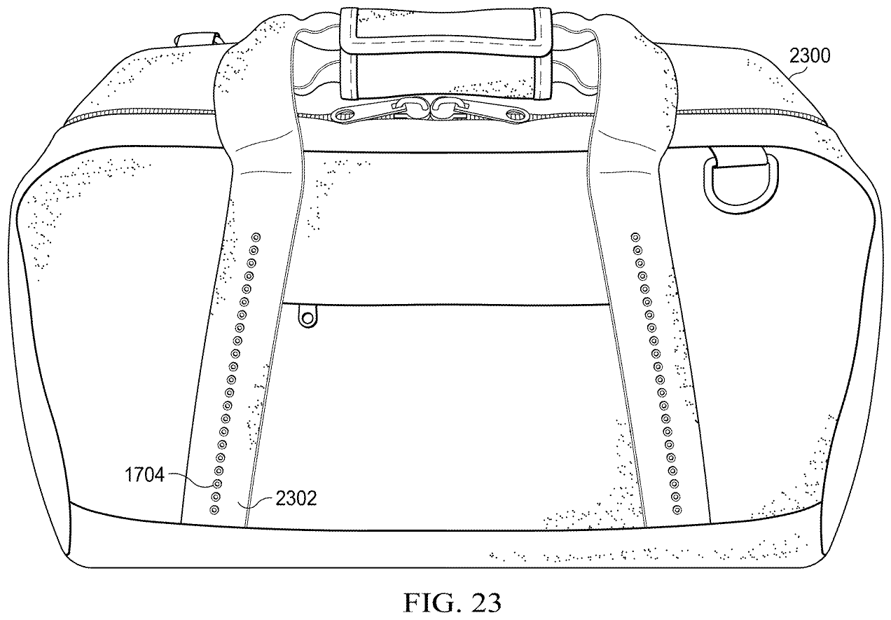

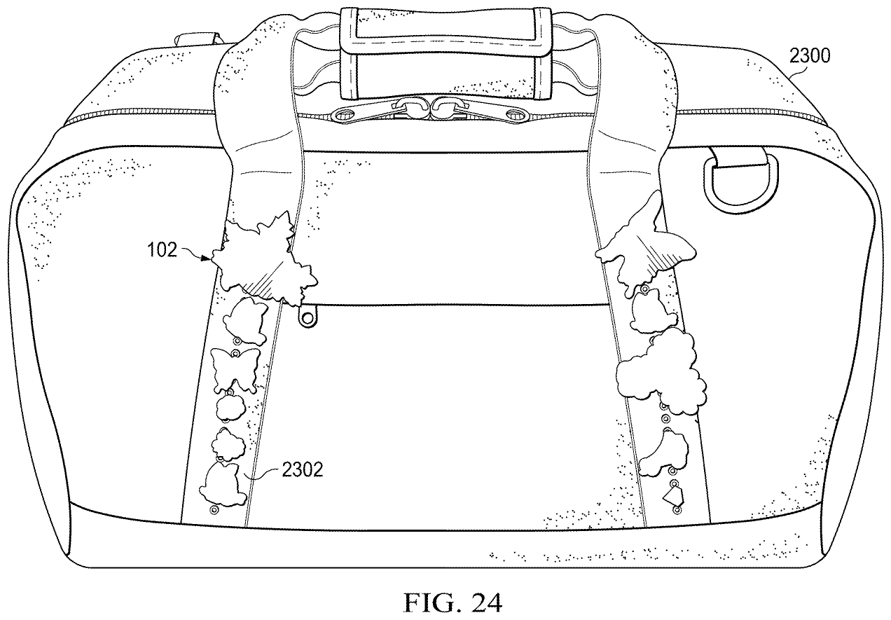

FIGS. 23 and 24 are various perspective views of an example duffel bag accessory 2300 with grommet-based vias 1704 in side straps 2302, in accordance with some embodiments of the present invention.

FIG. 23 illustrates a side perspective view of the duffel bag accessory 2300 having side straps 2302 with a pattern of grommet-based vias 1704, in accordance with some embodiments of the present invention.

FIG. 24 illustrates another side perspective view of the duffel bag accessory 2300 having side straps 2302 with several pin structures 102 in the grommet-based vias 1704, in accordance with some embodiments of the present invention.

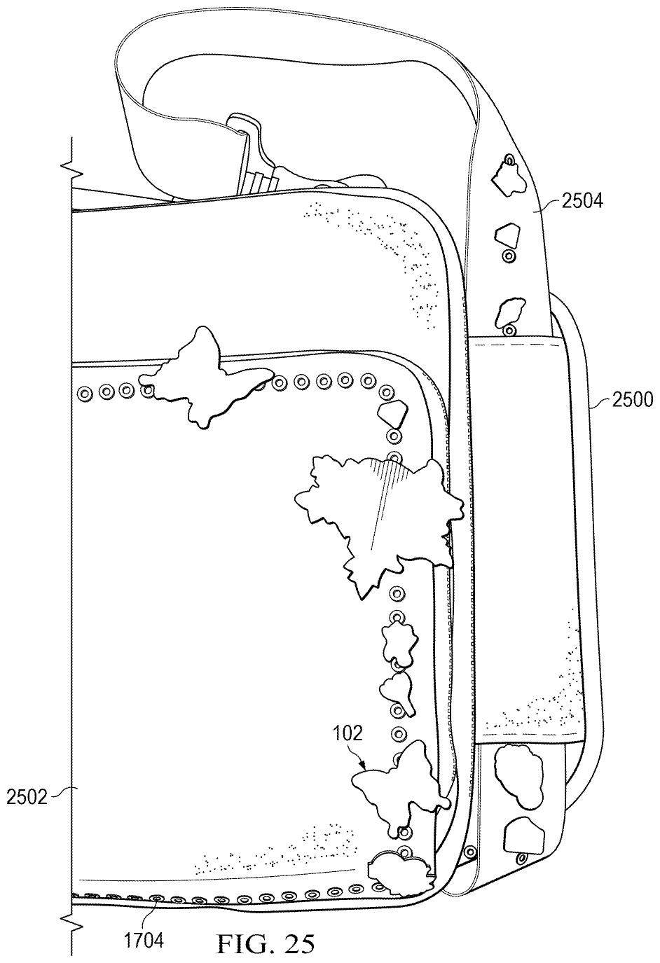

FIG. 25 is a perspective view of an example bag accessory 2500 with grommet-based vias 1704 in the face portion 2502 of the bag accessory 2500 as well as on straps 2504, in accordance with some embodiments of the present invention.

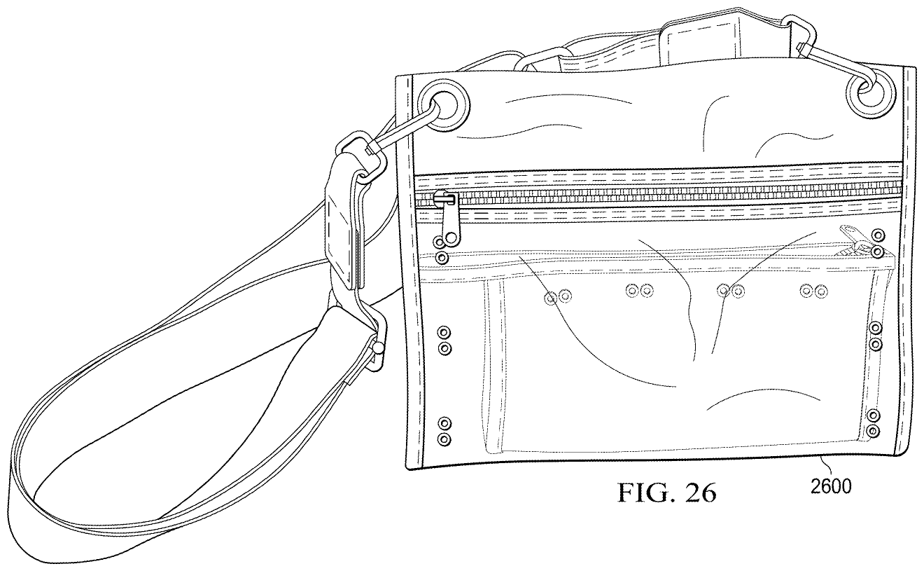

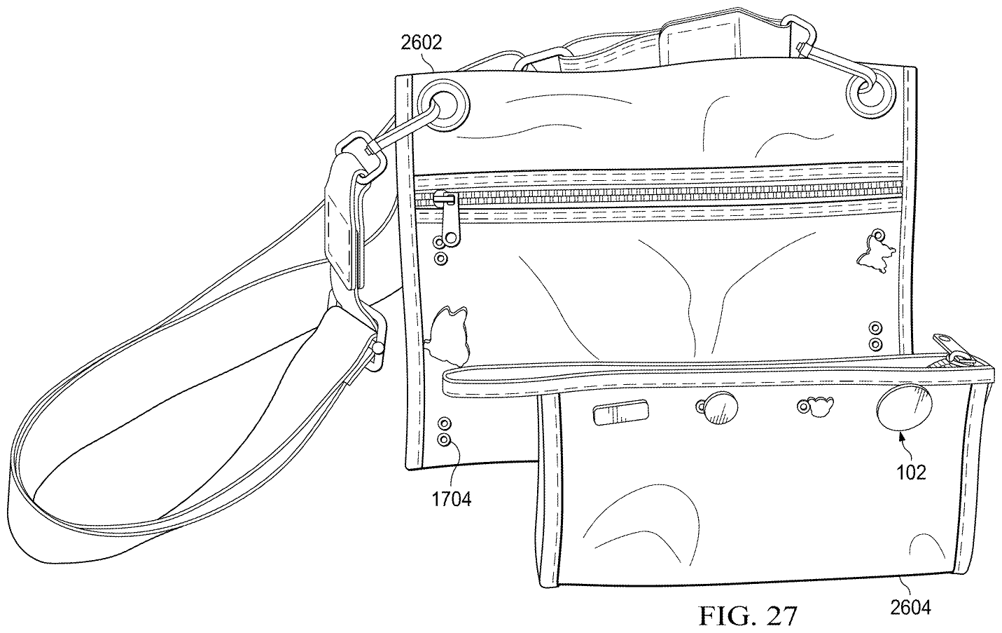

FIGS. 26 and 27 are various perspective views of an example stadium bag accessory product 2600 (larger bag accessory 2602 and nesting bag accessory 2604) with a pattern of grommet-based vias 1704 on the side face of the each of the larger bag accessory 2602 and nesting bag accessory 2604, in accordance with some embodiments of the present invention.

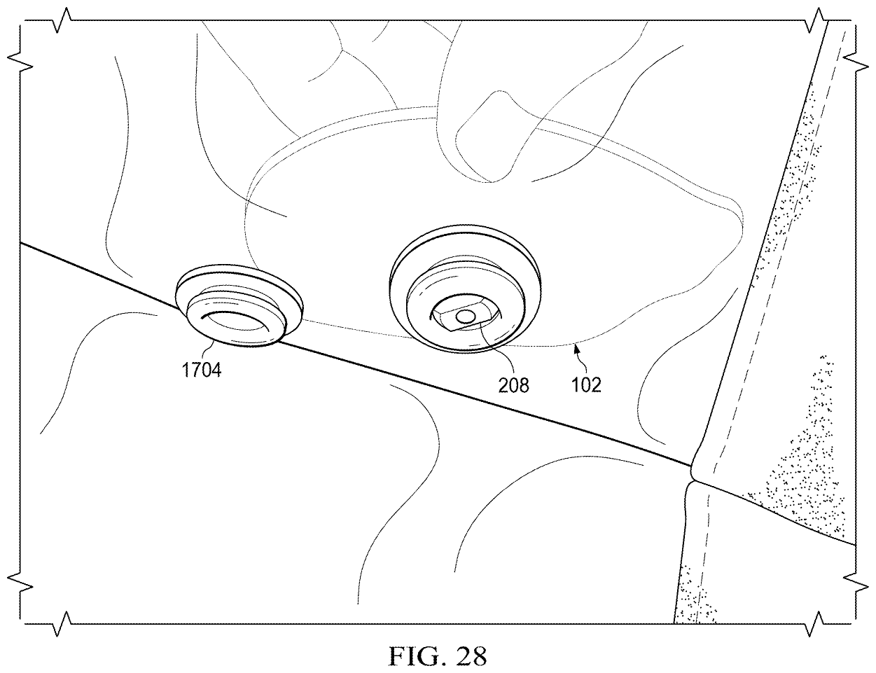

FIG. 28 is a perspective view of two grommet-based vias 1704 in one of the larger bag accessory 2602 or the nesting bag accessory 2604, with the right grommet-based via 1704 having a pin structure 102 retained therein, in accordance with some embodiments of the present invention. As shown, the connecting rod 204 is extending into the right grommet-based via 1704. As illustrated, the connecting rod 204 extends only partially into and does not extend through the grommet-based via 1704. Accordingly, in the illustrated embodiment, the retention component 208 is using the via wall to frictionally retain the pin structure 102 to the larger bag accessory 2602 or the nesting bag accessory 2604.

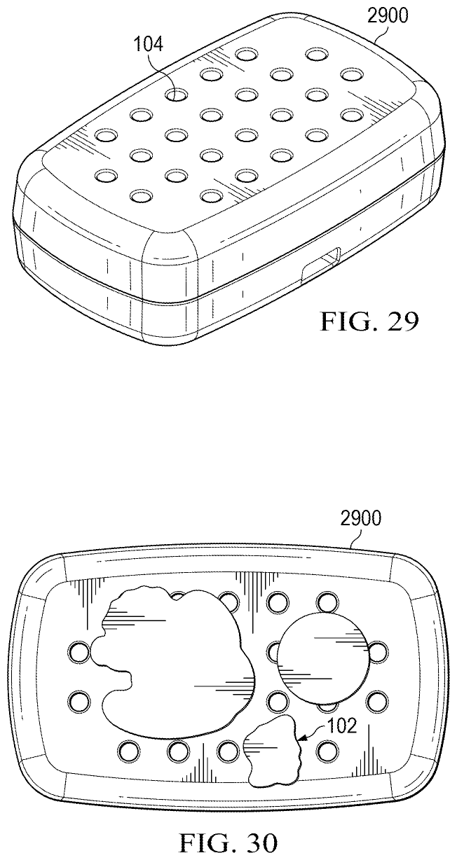

FIG. 29 illustrates an example earbud case accessory 2900 with a pattern of vias 104, in accordance with some embodiments of the present invention.

FIG. 30 illustrates the example earbud case accessory 2900 with several pin structures 102 in the vias 104, in accordance with some embodiments of the present invention.

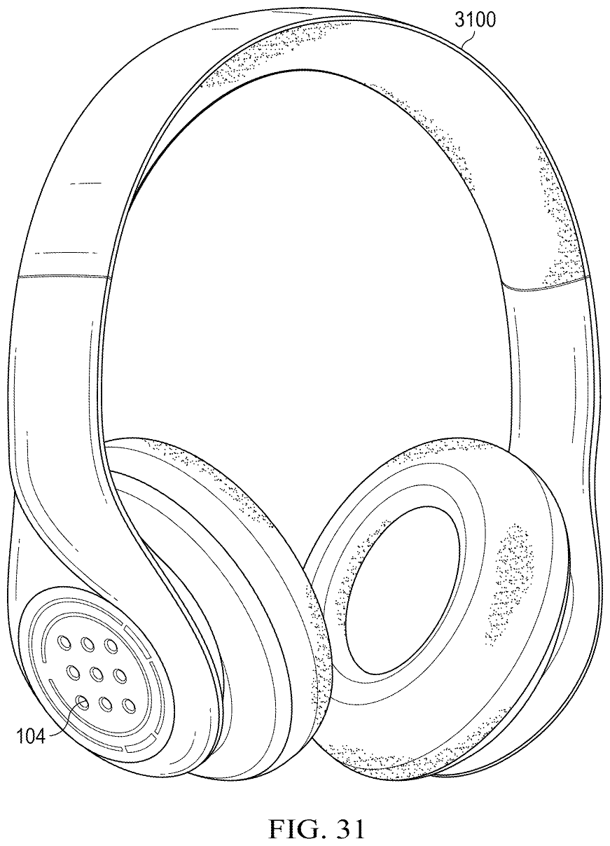

FIG. 31 illustrates an example headphone accessory 3100 with a pattern of vias 104, in accordance with some embodiments of the present invention.

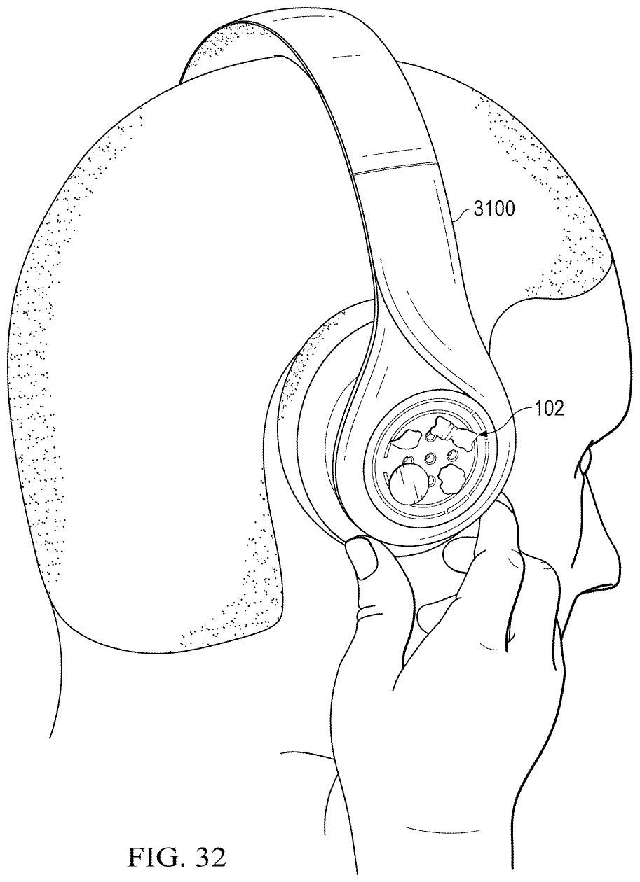

FIG. 32 illustrates the example headphone accessory 3100 with several pin structures 102 in the vias 104, in accordance with some embodiments of the present invention.

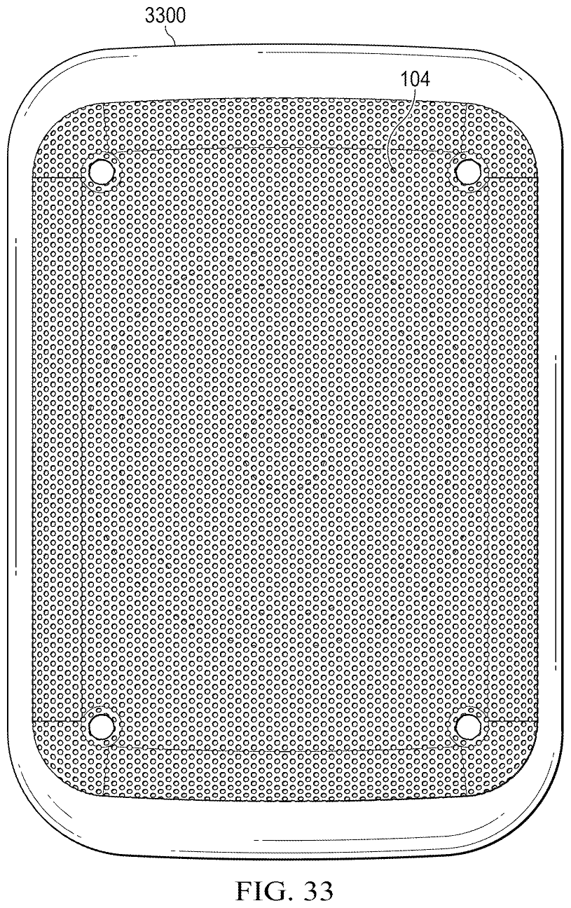

FIG. 33 illustrates an example wireless speaker accessory 3300 with a pattern of vias 104, in accordance with some embodiments of the present invention.

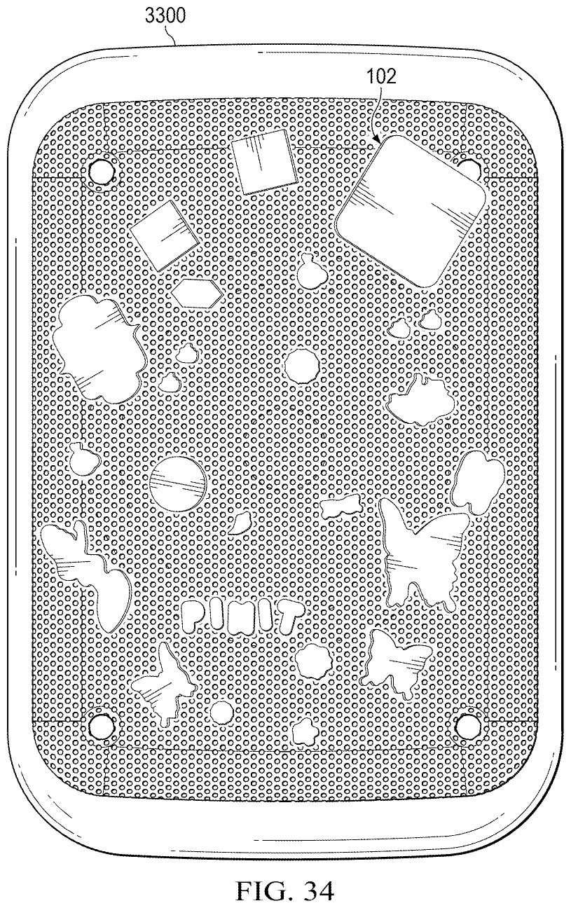

FIG. 34 illustrates the example wireless speaker accessory 3300 with several pin structures 102 in the vias 104, in accordance with some embodiments of the present invention.

Although not shown, in some embodiments, the back surface of the accessory 100, 1700, 2300, 2602, 2604 may include a protective layer (e.g., fabric) or other element that acts as a buffer between the retention components 208 and the object on the internal side, e.g., phone, device, or person. The protective layer enables the connecting rod 204 to extend through to the internal side of the accessory 100, but not directly contact an object on the other side.

In some embodiments, all vias 104, whether with or without grommets, may be sized according to fixed standard dimensions so that pin structures can be attached to any accessories having those standard vias 104. In some embodiments, all vias 104 need not have the same dimensions to cooperate with different sized pin structures. In some embodiments, all pin structures 102 need not have the same types of shafts 206 or retention components 208, such that different pin structures 104 may be retained using different types of connecting rods 204. In some embodiments, the external piece 202 may be rotationally mounted to the connecting rod 204, using for example ball bearings or other rotationally spinning mount. In some embodiments, the external piece 202 may be rotationally mounted to multiple connecting rods 204. Other embodiments are also possible.

The foregoing description of the preferred embodiments of the present invention is by way of example only, and other variations and modifications of the above-described embodiments and methods are possible in light of the foregoing teaching. The embodiments described herein are not intended to be exhaustive or limiting. The present invention is limited only by the following claims.

1. A pin structure, comprising:
an external piece;
a shaft coupled to the external piece and configured to extend into a via in an accessory; and
a retention component couped to the shaft and configured to interact with the via to retain the pin structure to the accessory.

2. The pin structure of claim 1, wherein the external piece is decorative.

3. The pin structure of claim 1, wherein the external piece includes a functional component.

4. The pin structure of claim 1, wherein the shaft includes a width smaller than a width of the via.

5. The pin structure of claim 1, wherein the shaft includes a length slightly longer than a length of the via.

6. The pin structure of claim 1, wherein the shaft includes a length shorter than a length of the via.

7. The pin structure of claim 1, wherein the retention component includes a widest part with a width larger than a width of the via.

8. The pin structure of claim 1, wherein the retention component includes a cylindrical portion and a conical slice portion.

9. The pin structure of claim 7, wherein the conical slice potion includes a distal end with width smaller than a width of the via.

10. The pin structure of claim 1, wherein the shaft and retention component include flat opposing sides.

11. The pin structure of claim 1, wherein the pin structure comprises at least one additional shaft coupled to the pin structure and at least one additional retention component coupled to the at least one additional shaft.

12. The pin structure of claim 11, wherein the two or more shafts and two or more retention components are configured to be inserted into adjacent vias in the accessory.

13. The pin structure of claim 1, wherein the shaft and the retention component have a hollow section therein or therethrough.

14. The pin structure of claim 1, wherein the via has a set size on two or more of different accessories, and wherein the connecting rod is configured to cooperate with the via of the set size.

15. The pin structure of claim 1, wherein the via has a set size on two or more of a phone case, headphone, phone charger, electronic device sleeve, product package, tablet case, laptop stand, keyboard, earbud case, backpack, duffel bag, purse, stadium bag, dog collar, dog apparel or human apparel, and wherein the connecting rod is configured to cooperate with the via of the set size.

16. The pin structure of claim 1, wherein the external piece and the shaft are separable.

17. The pin structure of claim 1, wherein the via in the accessory includes a grommet-based accessory.

18. The pin structure of claim 1, wherein the shaft and the retention component are integrally formed.

19. The pin structure of claim 1, wherein the shaft and retention component are different portions of screw-based threading.
